(19) United States
(12) Patent Application Publication
(10) Pub. No.: US 2025/0271268 A1
(43) Pub. Date: Aug. 28, 2025

(54) PUMP SYSTEMS AND METHODS FOR PROVIDING MULTIPLE STRAPDOWN SOLUTIONS IN ATTITUDE HEADING AND REFERENCE SYSTEM (AHRS)

(71) Applicant: L3 Technologies, Inc., Melbourne, FL (US)

(72) Inventors: David D. Haaland, Grand Rapids, MI (US); Paul Voisin, Grand Rapids, MI (US)

(73) Assignee: L3 Technologies, Inc., Melbourne, FL (US)

(21) Appl. No.: 19/088,461

(22) Filed: Mar. 24, 2025

Related U.S. Application Data
(63) Continuation-in-part of application No. 17/671,744, filed on Feb. 15, 2022, now Pat. No. 12,270,654.
Application No. 17/671,744 is a continuation-in-part of application No. 16/352,423, filed on Mar. 13, 2019, now abandoned.
(60) Provisional application No. 62/642,324, filed on Mar. 13, 2018.

(51) Int. Cl. G01C 21/16; B60W 40/11; B60W 40/112

(52) U.S. Cl. CPC G01C 21/16; B60W 40/11; B60W 40/112; B60W 2520/16; B60W 2520/18

(57) ABSTRACT

An inertial navigation system is provided including sensors and a controller coupled to the sensors. A method of the system includes, at each of multiple iterations: receiving first outputs and second outputs from the sensors; applying a first Gaussian curve to the first outputs, and a second Gaussian curve to the second outputs; weighting each of the first outputs based on a position on the first Gaussian curve of each of the first outputs, and each of the second outputs based on a position on the second Gaussian curve of each of the second outputs; determining a combined first output based on the weighting of the first outputs and determining a combined second output based on the weighting of the second outputs; and calculating at least two of a roll, a pitch, and a heading based on the combined first output and combined second output.

### CROSS-REFERENCE TO RELATED APPLICATIONS

This Application is a Continuation-in-part of U.S. application Ser. No. 17/671,744, filed Feb. 15, 2022, which Application is a Continuation-in-part of U.S. application Ser. No. 16/352,423, filed Mar. 13, 2019, which Application claims the benefit of U.S. Provisional Application 62/642,324, filed Mar. 13, 2018, the disclosures of which are hereby incorporated herein by reference in their entireties.

### BACKGROUND

### 1. Field

Apparatuses and methods consistent with exemplary embodiments relate Various systems benefit from suitable mechanisms and methods for dealing with sensor inaccuracy. For example, various attitude and heading reference system (AHRS) approaches may benefit from systems and methods for providing multiple strapdown solutions.

### 2. Description of the Related Art

An inertial strapdown system may use rate sensors and accelerometers to compute any of roll, pitch, heading, position, and any of various other values. If one of these sensors fails, or is not accurate enough for any reason, for example due to a noise source, the attitude (roll and pitch) and heading may become either invalid or inaccurate.

A Built-In-Test (BIT) can detect sensor failures and mark the output of a sensor as failed when the sensor fails its BIT. However, one shortcoming of such a solution is the loss of attitude/heading when a sensor fails in the field. Furthermore, it is difficult to design a BIT such that the attitude/heading solution of a failing sensor is marked as invalid before it becomes too highly inaccurate, but is not needlessly marked as invalid. In other words, it is hard to balance between trusting inaccurate data (BIT doesn't fail when it should) and generating false or spurious reports of failure (BIT fails when it shouldn't).

### SUMMARY

One or more example embodiments described herein may address at least the above problems and/or disadvantages and other disadvantages not described above. Also, example embodiments are not required to overcome the disadvantages described above, and may not overcome any of the problems described above.

According to an aspect of an example embodiment, an inertial navigation method of a vehicle may comprise: receiving, at a controller of the vehicle, at each of a plurality of iterations, a plurality of first outputs from a corresponding plurality of sensors; and a plurality of second outputs from the corresponding plurality of sensors; at each of the plurality of iterations: applying a first Gaussian curve to the plurality first outputs; and a second Gaussian curve to the plurality of second outputs; weighting each of the plurality of first outputs based on a position on the first Gaussian curve of each of the plurality of first outputs; and each of the plurality of second outputs based on a position on the second Gaussian curve of each of the plurality of second outputs; determining a combined first output based on the weighting of the plurality of first outputs and determining a combined second output based on the weighting of the plurality of second outputs; and calculating a roll of the vehicle based on the combined first output, and a pitch of the vehicle based on the combined second output; and at each of the plurality of iterations: controlling at least one of an engine of the vehicle and a control surface of the vehicle based on the roll of the vehicle and the pitch of the vehicle.

The inertial navigation method may further comprise: at each of the plurality of iterations: outputting the roll of the vehicle and the pitch of the vehicle to a navigation system of the vehicle; wherein the controlling may comprise the navigation system of the vehicle controlling at least one of the engine of the vehicle and a control surface of the vehicle.

The first Gaussian curve may be one of a first Probability Distribution Function, a first Cauchy Distribution, and a first Logistic Distribution, and the second Gaussian curve may be one of a second Probability Distribution Function, a second Cauchy Distribution, and a second Logistic Distribution.

The receiving may further comprise, at each of the plurality of iterations: a plurality of third outputs from the corresponding plurality of sensors; at each of the plurality of iterations: the applying may further comprise applying a third Gaussian curve to the plurality of third outputs; the weighting may further comprise weighting each of the plurality of third outputs based on a position on the third Gaussian curve of each of the plurality of third outputs; the determining may further comprise determining a combined third output based on the weighting of the plurality of third outputs; and the calculating may further comprise calculating a heading of the vehicle based on the combined third output; and at each of the plurality of iterations, the controlling may further comprise controlling at least one of the engine of the vehicle and the control surface of the vehicle based on the heading of the vehicle.

According to an aspect of another example embodiment, a vehicle may comprise: an engine; and an inertial navigation system comprising: a plurality of sensors, each configured to measure a first physical quantity from which can be computed a roll of the vehicle, and a second physical quantity from which can be computed a pitch of the vehicle; a memory storing instructions therein; and a controller, operatively coupled to each of the plurality of sensors, the controller configured to execute the instructions and thereby: receive a plurality of first outputs, corresponding to the first physical quantity, from the plurality of sensors, and receive a plurality of second outputs, corresponding to the second physical quantity, from the plurality of sensors; apply a first Gaussian curve to the plurality of first outputs and apply a second Gaussian curve to the plurality of second outputs; weight each of the plurality of first outputs based on a position on the first Gaussian curve of each of the plurality of first outputs and weight each of the plurality of second outputs based on a position on the second Gaussian curve of each of the plurality of second outputs; determine a combined first output based on the weighting of the plurality of first outputs and determine a combined second output based on the weighting of the plurality of second outputs; calculate a roll of the vehicle based on the combined first output, and a pitch of the vehicle based on the combined second output; and control at least one of the engine and a control surface of the vehicle based on the roll of the vehicle and the pitch of the vehicle.

The first Gaussian curve may be one of a first Probability Distribution Function, a first Cauchy Distribution, and a first Logistic Distribution, and the second Gaussian curve may be one of a second Probability Distribution Function, a second Cauchy Distribution, and a second Logistic Distribution.

Each of the plurality of sensors may be further configured to measure a third physical quantity form which can be computed a heading of the vehicle; and the controller may be further configured to receive a plurality of third outputs, corresponding to the third physical quantity, from the plurality of sensors, apply a third Gaussian curve to the plurality of third outputs, weigh each of the plurality of third outputs based on a position on the third Gaussian curve of each of the plurality of third outputs, determine a combined third output based on the weighting of the plurality of third outputs, calculate a heading of the vehicle based on the combined third output, and control the at least one of the engine and the control surface of the vehicle based on the heading of the vehicle.

The first Gaussian curve may be one of a first Probability Distribution Function, a first Cauchy Distribution, and a first Logistic Distribution; the second Gaussian curve may be one of a second Probability Distribution Function, a second Cauchy Distribution, and a second Logistic Distribution; and the third Gaussian curve may be one of a third Probability Distribution Function, a third Cauchy Distribution, and a third Logistic Distribution.

According to an aspect of another example embodiment, a non-transitory computer-readable medium may be encoded with instructions that, when executed in hardware, perform an inertial navigation process comprising: receiving, at each of a plurality of iterations, a plurality of first outputs from a corresponding plurality of sensors; and a plurality of second outputs from the corresponding plurality of sensors; at each of the plurality of iterations: applying a first Gaussian curve to the plurality first outputs; and a second Gaussian curve to the plurality of second outputs; weighting each of the plurality of first outputs based on a position on the first Gaussian curve of each of the plurality of first outputs; and each of the plurality of second outputs based on a position on the second Gaussian curve of each of the plurality of second outputs; determining a combined first output based on the weighting of the plurality of first outputs and determining a combined second output based on the weighting of the plurality of second outputs; and calculating a roll based on the combined first output, and a pitch based on the combined second output.

The inertial navigation process may further comprise at each of the plurality of iterations: outputting the roll and the pitch to a navigation system.

The first Gaussian curve may be one of a first Probability Distribution Function, a first Cauchy Distribution, and a first Logistic Distribution, and the second Gaussian curve may be one of a second Probability Distribution Function, a second Cauchy Distribution, and a second Logistic Distribution.

The receiving may further comprise: at least of the plurality of iterations, receiving a third plurality of outputs form the corresponding plurality of sensors; and, at each of the plurality of iterations: the applying may further comprise applying a third Gaussian curve to the plurality of third outputs, the weighting may further comprise weighting each of the plurality of third outputs based on a position on the third Gaussian curve of each of the plurality of third outputs, the determining may further comprise determining a combined third output based on the weighting of the plurality of third outputs, and the calculating may further comprise calculating a heading of the vehicle based on the combined third output.

The inertial navigation process may further comprise, at each of the plurality of iterations: outputting the roll, the pitch, and the heading to a navigation system.

The first Gaussian curve may be one of a first Probability Distribution Function, a first Cauchy Distribution, and a first Logistic Distribution; the second Gaussian curve may be one of a second Probability Distribution Function, a second Cauchy Distribution, and a second Logistic Distribution; and the third Gaussian curve may be one of a third Probability Distribution Function, a third Cauchy Distribution, and a third Logistic Distribution.

### BRIEF DESCRIPTION OF THE DRAWINGS

The above and/or other example aspects and advantages will become apparent and more readily appreciated from the following description of example embodiments, taken in conjunction with the accompanying drawings, in which:

FIG. 1 illustrates a system according to an example embodiment;

FIG. 2 illustrates a connection scheme of a system according to an example embodiment;

FIG. 3 illustrates a probability distribution function (PDF) according to an example embodiment;

FIGS. 4A and 4B illustrate differences in results between applying an average weighting method and applying a Gaussian method to a sample set A, and a sample set B, respectively, according to example embodiments;

FIG. 4C illustrates examples of Gaussian curves with different centers and weights according to an example embodiment;

FIG. 5 illustrates a connection scheme of a system according to another example embodiment;

FIG. 6 is a flow chart of a method according to an example embodiment; and

FIG. 7 is a flow chart of a method according to another example embodiment.

Applicant notes that the accompanying drawings are provided for purposes of illustration and not by way of limitation.

### DETAILED DESCRIPTION

Reference will now be made in detail to example embodiments which are illustrated in the accompanying drawings, wherein like reference numerals refer to like elements throughout. In this regard, the example embodiments may have different forms and may not be construed as being limited to the descriptions set forth herein.

It will be understood that the terms “include,” “including,” “comprise,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be further understood that, although the terms “first,” “second,” “third,” etc., may be used herein to describe various elements, components, regions, layers and/or sections, these elements, components, regions, layers and/or sections may not be limited by these terms. These terms are only used to distinguish one element, component, region, layer or section from another element, component, region, layer or section.

As used herein, the term “and/or” includes any and all combinations of one or more of the associated listed items. Expressions such as “at least one of,” when preceding a list of elements, modify the entire list of elements and do not modify the individual elements of the list.

Various terms are used to refer to particular system components. Different companies may refer to a component by different names—this document does not intend to distinguish between components that differ in name but not function.

Matters of these example embodiments that are obvious to those of ordinary skill in the technical field to which these exemplary embodiments pertain may not be described here in detail.

One or more example embodiments may provide additional reliability for inertial strapdown systems using multiple redundant sensors. According to one or more example embodiments, multiple sensors may be used (for example, multiple three-axis rate sensors, multiple accelerometers, both, or any other desired multiple sensors); multiple strapdown solutions may be calculated; and the resulting roll, pitch, heading and any other desired values may be combined using a desired algorithm, such as a weighted average, to compute a more reliable output than one that depends on just one of each type of sensor.

One or more example embodiments may enhance reliability in two ways: (1) the solution may be less affected by noise in the sensors, because noise in multiple sensors may, to a certain extent, cancel each out, and (2) a RIT may be computed by simply comparing the output roll, pitch, and heading of the multiple sensors. In a case in which one strapdown solution differs from others by some threshold amount, that solution may be ignored, for example, in the combined output. The combined output need not be invalidated just because one or more of the solutions is not used. As long as a sufficient minimum number of solutions agree with each other, the combined output can be considered valid. In this way, redundancy of multiple inertial systems may be achieved within one inertial product.

One or more example embodiments may be used with avionics, space vehicles, guided weapons, such as missiles, hand-held devices, or any other application which may use an inertial strapdown solution for computing one or more of roll, pitch, heading, position (or any other desired parameter).

### Sensors—Example Embodiments

One or more example embodiments may implement multiple strapdown solutions in a single Attitude and Heading Reference System (AHRS) product (or, if desired, in multiple AHRS products). One or more example embodiments may provide a product that may contain multiple sets of three rate sensors: x, y, and z. Each set of x, y, and z sensors may comprise a single three-axis package, or may include three separate packages arranged orthogonally. In a case in which multiple three-axis packages (three-axis sensors) are used, the multiple three-axis sensors sets may be arranged to have all of their x axes parallel, y axes parallel, and z-axes parallel, for example. Alternatively, they may be arranged to have a first sensor's positive x axis parallel to a second sensor's positive y axis, the first sensor's positive y axis parallel to the second sensor's negative x axis, and so on. As would be understood by one of skill in the art, these arrangements are examples, and multiple three-axis sensors may be arranged in any of various arrangements, including in a non-parallel manner (for instance, the x axis of one three-axis sensor may point into the middle of the first, second, or third, etc., octant of another three-axis sensor).

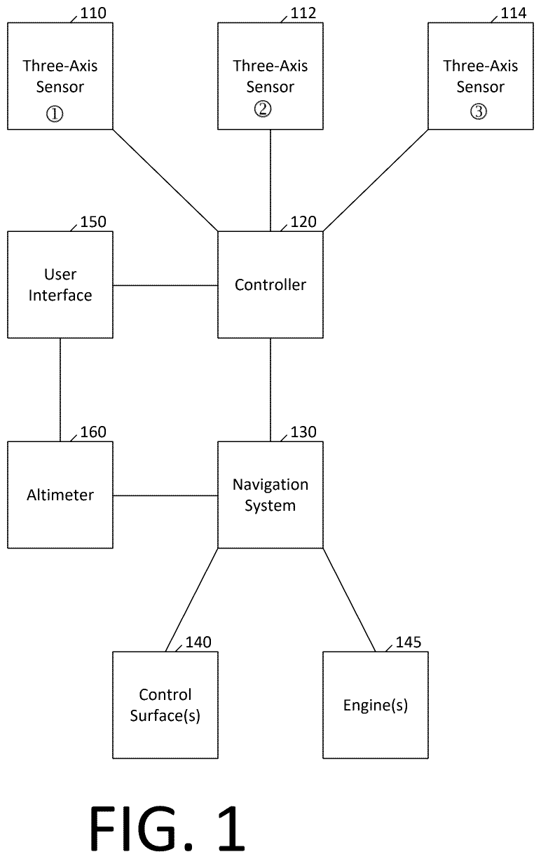

FIG. 1 illustrates a system according to an example embodiment. As shown in FIG. 1, a system can include a plurality three-axis sensors 110, 112, 114. There can be more or fewer than three such sensors. Moreover, the sensors may be other kinds of sensors, such as two-axis sensors or eight-axis sensors. These sensors, therefore, are provided as an illustration and not by way of limitation. As discussed, each of the sensors 110, 112, 114 may comprise a three-axis sensor in a single package or may comprise three separate packages, one for each of the three axe, arranged orthogonally.

Each of sensors 110, 112, 114 may be a strapdown sensor. A strapdown sensor may be a sensor that does not require an inertial platform as a mounting point, but may be strapped down at any desired place on a vehicle. The particular mounting mechanism of strapping with straps is not required. Optionally, sensors 110, 112, 114 may be mounted to a rotating platform.

### Controller—Example Embodiments

The system can also include a controller 120, as shown in FIG. 1. The controller 120 can be implemented, at least in part, in digital electronic circuitry, analog electronic circuitry, or in computer hardware, firmware, software, or a combination thereof. According to one or more example embodiments, an individual controller 120 may be packaged together with each of the sensors 110, 112, 114. Alternately, or in addition, the controller 120 may be packaged together with all of the sensors 110, 112, 114 (not shown). Alternately, or in addition, the controller 120 may separate from each of the sensors, as shown in FIG. 1. Alternately, or in addition, the controller 120 may be part of a vehicle guidance system of a vehicle. The vehicle may be, for example, an unmanned aerial vehicle (UAV) or other vehicle.

The controller 120 may be configured to receive, as inputs, the outputs of sensors 110, 112, 114. The sensors 110, 112, 114 may provide raw outputs or signals representative of roll, pitch, and optionally heading. The sensors 110, 112, 114 may provide roll, pitch, and heading in a coordinate system of the corresponding sensor. The controller 120 may then be calibrated to interpret the sensor data with a predetermined motion of the device, by comparison to other known values, or any other desired way.

Components of the controller 120 can be implemented, for example, as a computer program product such as a computer program, program code or computer instructions tangibly embodied in an information carrier, or in a machine-readable storage device, for execution by, or to control the operation of, data processing apparatus such as a programmable processor, a computer, or multiple computers.

The computer program product may comprise a computer-readable media storing program instructions, executable by a processor, to implement various operations. The media may include, alone or in combination with the program instructions, data files, data structures, and the like. The media and program instructions may be specially designed and constructed for the purposes of example embodiments described herein, or they may be of a kind well-known and available to those of skill in the art. Examples of computer-readable media include, but are not limited to: magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also include a transmission medium such as one or more of optical lines, electrically-conductive lines, and wave guides. Examples of program instructions include, but are not limited to: machine code, such as produced by a compiler; and files containing higher level code that may be executed by the controller using an interpreter. Hardware devices described herein may be configured to act as one or more software modules in order to perform the operations of one or more example embodiments described herein.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or other device or on multiple device at one site or distributed across multiple sites and interconnected by a communication network. Also, functional programs, codes, and code segments for accomplishing features described herein can be easily developed by programmers skilled in the art. Operations associated with the example embodiments can be performed by one or more programmable processors executing a computer program, code or instructions to perform functions (e.g., by operating on input data and/or generating an output). Operations can also be performed by, and apparatuses described herein can be implemented as, special purpose logic circuitry, e.g., a field programmable gate array (FPGA) or an application-specific integrated circuit (ASIC), for example.

The various illustrative logical blocks, modules, and circuits described in connection with the embodiments disclosed herein may be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory (ROM) (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Computer-readable non-transitory media includes all types of computer readable media, including magnetic storage media, optical storage media, flash media and solid state storage media. It should be understood that software can be installed in and sold with a central processing unit (CPU) device. Alternately, software can be obtained and loaded into the CPU device, including obtaining the software through physical medium or distribution system, including, for example, from a server owned by the software creator or from a server not owned but used by the software creator. The software can be stored on a server for distribution over the Internet, for example. \textcircled{1} \textcircled{2} \textcircled{3}

### Strapdown Integration and Combining Outputs—Example Embodiments

According to one or more example aspects, rates generated from each of the sensors can be mathematically rotated to provide multiple rate vectors in a same three-dimensional Cartesian reference system according to a strapdown integration algorithm. The number of x-y-z triads could be increased by combining axes from different sensor triads. For instance, the x axis from sensor 110 \textcircled{1} with the y and z axes from sensor 112 \textcircled{2}. In this manner, as many as eight different three-dimensional rate vectors could be generated from two three-axis sensor triads.

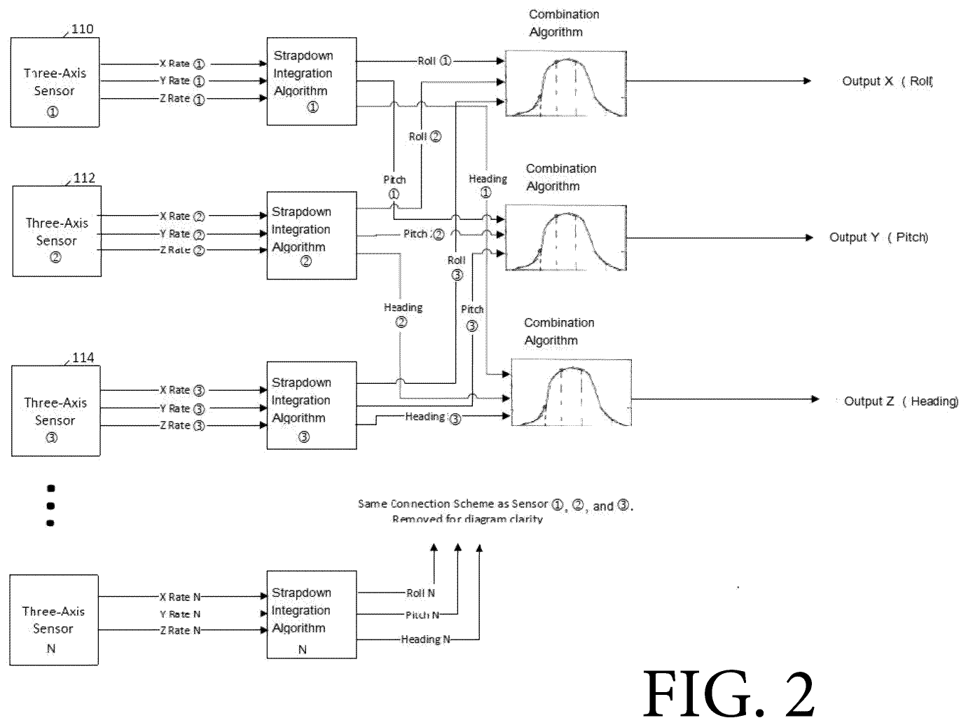

### Example Embodiment—FIG. 2—Strapdown

A strapdown integration algorithm for each of the sensors may be executed by the controller 120. For example, according to one example aspect, each three-dimensional rate vector from each sensor 110, 112, 114 may be fed into its own strapdown integration algorithm to compute its own set of roll and pitch (and heading, if a heading reference, such as a magnetometer, is provided). FIG. 2 illustrates a connection scheme of a system according to an example embodiment. As shown in FIG. 2, each of the sensors 110, 112, 114 outputs an x-rate, a y-rate, and a z-rate, for example, but not limited to rates corresponding to a roll, a pitch, and a heading, respectively, and for each of the sensors, the output rates are input into a strapdown integration algorithm, for example as executed by the controller 120.

As discussed with respect to this example embodiment, the controller 120 may determine each of a plurality of strapdown solutions. Each strapdown solution including, for example, roll and pitch. Alternately, each strapdown solution may also include heading.

### Example Embodiment—FIG. 2—Combination

As shown in the example embodiment of FIG. 2, an x-output (e.g. roll) from each of the strapdown integration algorithms, may be input to a combination algorithm, for example, as executed by the controller 120. Likewise, y-outputs (e.g. pitch) and z-outputs (e.g. heading) from each of the strapdown integration algorithm, may be input to a respective combination algorithm. The respective combination algorithms determine an x-output (e.g. roll), y-output (e.g. pitch), and z-output (e.g. heading) that are output from the controller 120.

In a case in which all of the sensors 110, 112, 114 are providing accurate, valid data, the combining of the strapdown integration outputs (e.g., calculation of the output roll, output pitch, and output heading from the outputs from each strapdown integration algorithm) can be straightforward: they can simply be averaged. However, if one sensor fails, there may be a graceful way to drop the failing sensor's strapdown solution from the final output without causing steps in the final outputs. In other words, the output roll, pitch, and heading, when one sensor is failing can be smooth as the output roll, pitch, and heading when all sensors are operating accurately.

According to one or more example embodiments, the combination algorithm may utilize a weighted average or another suitable solution. At each iteration of new outputs from the sensors (e.g., roll, pitch and heading), a median of the outputs from the strapdown integration algorithms may be computed by the combination algorithm. The Gaussian function, or other probability function, as would be understood by one of skill in the art, may then be applied to the outputs with its mean at the median of the outputs. The weight of each output may then be determined by its position on the probability curve. One reason for using the median instead of the mean may be that as one solution begins to move away from the others, the median does not move off with it, whereas the mean does.

According to one or more example embodiments, for each of the roll and heading, a circular version of the median and weighted mean may be computed by the combination algorithm. A circular median may be computed by taking the sine and cosine of all the angles, finding the median of the sines and cosines, and computing the quadrant-specific arctangent using the median sine and cosine. A weighted circular mean may be computed by taking the sines and cosines of all the angles, and computing a weighted mean of the sines and cosines. Then, the quadrant-specific arctangent may be computed from the weighted mean of the sines and the weighted mean of the cosines. For pitch, a simple median and weighted mean or a circular mean may be used by the combination algorithm. This is because the range for pitch is only +/−90 degrees.

According to the example embodiment of FIG. 2, an attitude validity may be determined not by testing the individual sensors, but by comparing the output attitude/heading solutions. If one solution begins to drift away from the others, it may be dropped-gradually phased out by the weighting scheme described above (or any other suitable scheme). In order for the combined solution to remain valid, a minimum number of solutions can be established, and that minimum number of solutions may be maintained within some minimum range of the median (described above). Heading validity may be established separately from roll/pitch validity, because in some installations there may be no heading reference (such as a magnetometer), so the system outputs roll and pitch.

As discussed with respect to this example embodiment, the controller 120 may weight each solution, or part thereof, based on a relation between a given output and the other outputs.

The weighting performed by the combination algorithm can be performed in any of various ways. For example, the controller 120, via a combination algorithm/combination algorithm, may determine a median of the solutions (e.g. a median of the roll 1), the roll 2, and the roll 33, as output from the strapdown integration algorithms) and may weight each solution based on a relation between a given input and the median. The controller 120 may then determine roll, pitch, and heading for the device based on the weighted plurality of inputs.

According to one or more example embodiments, weighting performed by the combination algorithm(s) can take account of the roll and pitch separately, while in other example embodiments, roll and pitch can be weighted together. According to one or more example embodiments, heading data may be output from a different underlying sensor type. Thus, in certain example embodiments, the heading may be weighted separately from pitch and roll, even when pitch and roll are weighted together.

The combination algorithm, e.g. as part of the controller 120, can be configured to weight a given solution based on its position on the probability curve, as described above, for example.

In a situation in which an output from a given sensor is weighted as zero, for example due to a sensor failure, the solution from the given sensor may be removed from consideration, even as to determining a median, after a predetermined amount of time. According to one or more example embodiments, this may mean removing all outputs from the sensor from consideration. Alternately, this may mean removing only one or more outputs from the sensor (e.g. only one or two of a roll, pitch, and heading) from consideration. According to one or more example embodiments, the heading output from a sensor may be removed from consideration while the roll and pitch outputs from the sensor may continue to be considered. This approach may have an advantage of permitting sensors to continue in partial use.

The median of at least one of the roll, the pitch, or the heading can be determined by computing a circular median or mean, as explained above. This calculation can be performed by the controller 120.

According to an example aspect of one or more example embodiments, the weighting may include iteratively determining a Gaussian curve for each of a plurality of outputs, e.g. a Gaussian curve for each of a roll, a pitch, and a heading, and a weight may be applied to one or more of the outputs based on the Gaussian curve.

According to an example aspect of one or more example embodiments, the weighting may include assuming the noise to be additive white Gaussian. A variance of noise may be estimated from the median value of the wavelet coefficients at the first scale. Then, a threshold may be determined that is based on normalizing the noise distribution. Noisy coefficients and the best threshold may be determined. The inverse wavelet transform is then performed, and the resulting signal is the denoised signal.

Alternately, according to an example aspect of one or more example embodiments, rather than removing white noise by assuming that the noise has a Gaussian profile, a Gaussian curve may be iteratively applied to the sensor outputs, and the sensor outputs may then be iteratively weighted based on their position on the curve. This iterative application of the Gaussian profile, and iterative weighting may avoid a step response in which one sample/sensor output goes from being considered to being omitted entirely. The weighting of samples/sensor outputs may be linearly reduced. When the Gaussian curve is applied iteratively, at each iteration, the values near the center of the curve may receive full or near full weighting, while values closer to the tails of the function may receive less, near zero, or zero weight, as they approach the end of the tail.

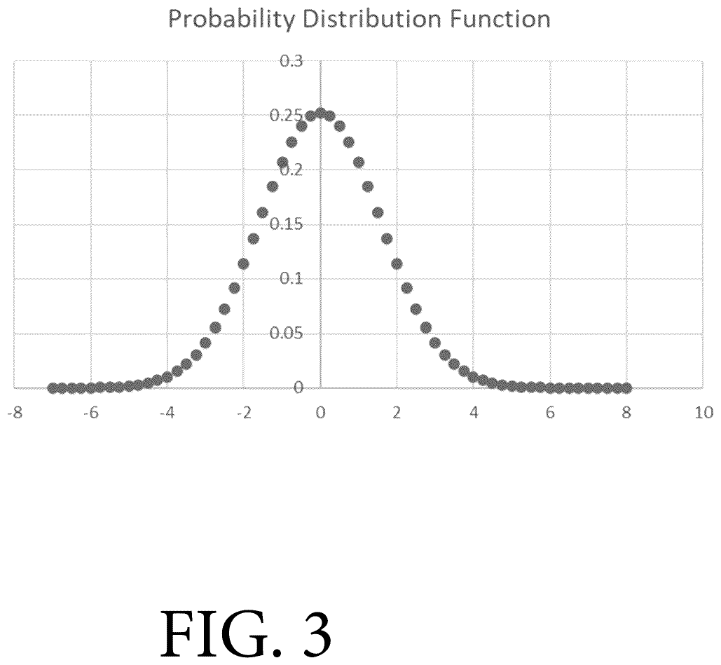

The Gaussian curve applied may be a Probability Distribution Function (PDF), which is bell-shaped, continuous, and smooth. FIG. 3 illustrates a PDF according to an example aspect. Alternately, any of a variety of other curve types may be used, including, but not limited to a Cauchy Distribution, and a Logistic Distribution.

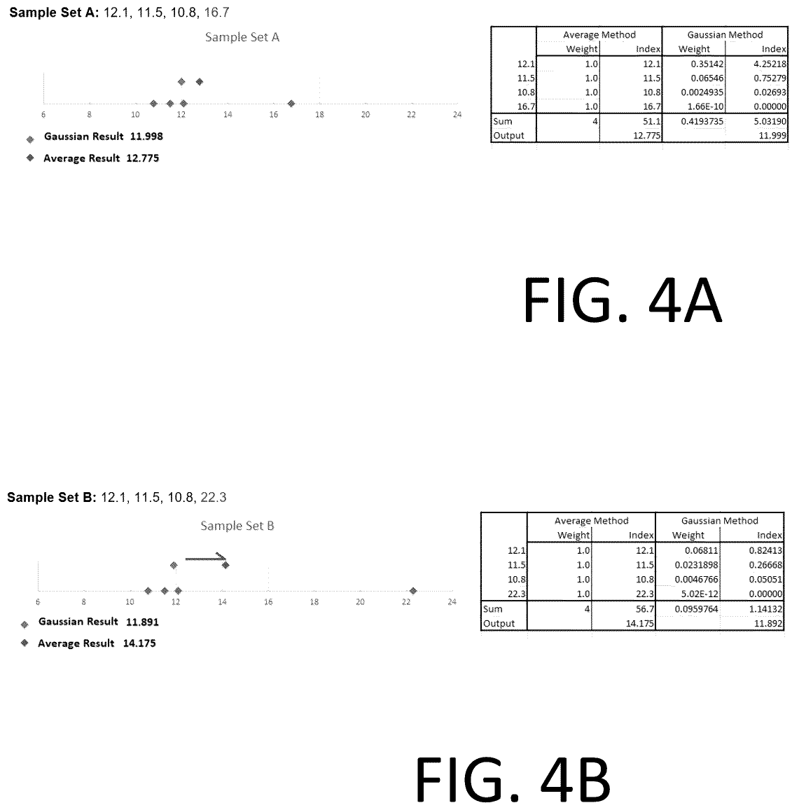

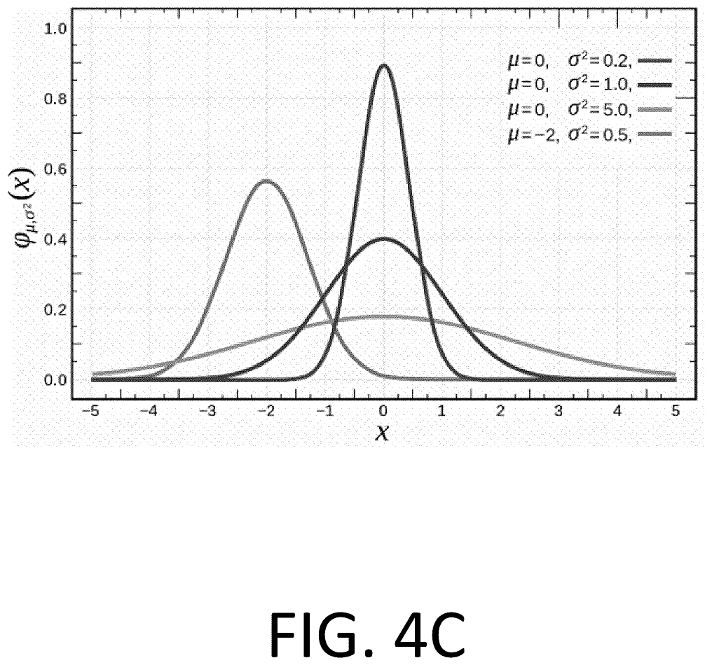

FIG. 4A illustrates a difference in results between applying an average weighting method and applying a Gaussian method according to an example embodiment to sample set A: 12.1, 11.5, 10.8, and 16.7; and FIG. 4B illustrates a difference in results between applying an average weighting method and applying a Gaussian method according to an example embodiment to an example sample set B: 12.1, 11.5, 10.8, and 22.3. In sample set A, a single outlier is 16.7, while in sample set B, the single outlier is 22.3. It is evident that, with respect to the average result, the output shifted somewhat substantially from 12.775 to 14.175 from sample A to sample B, due to the effect of the outlier. However, the Gaussian weighted output shifted only slightly from 11.998 to 11.891, discounting the faulty sensor represented by the outlier. In these examples of FIGS. 4A and 4B, the width of the Gaussian distribution (weights) is a linear function of the difference between the maximum and minimum samples. The center of the Gaussian distribution is the average of all the samples. Therefore, according to an example embodiment, the width and the center of the weighting curve moves with the sample set. These adjustments may be calculated by one of skill in the art.

According to one or more example embodiments, a Gaussian curve may be applied to sensor outputs related to the roll and pitch of a device, and a different Gaussian curve may be applied to sensor outputs related to the heading of a device. In this way, the solutions related to the roll and pitch of the device may be weighted differently than the solutions related to the heading of the device.

FIG. 4C illustrates examples of Gaussian curves with different centers and weights according to an example embodiment.

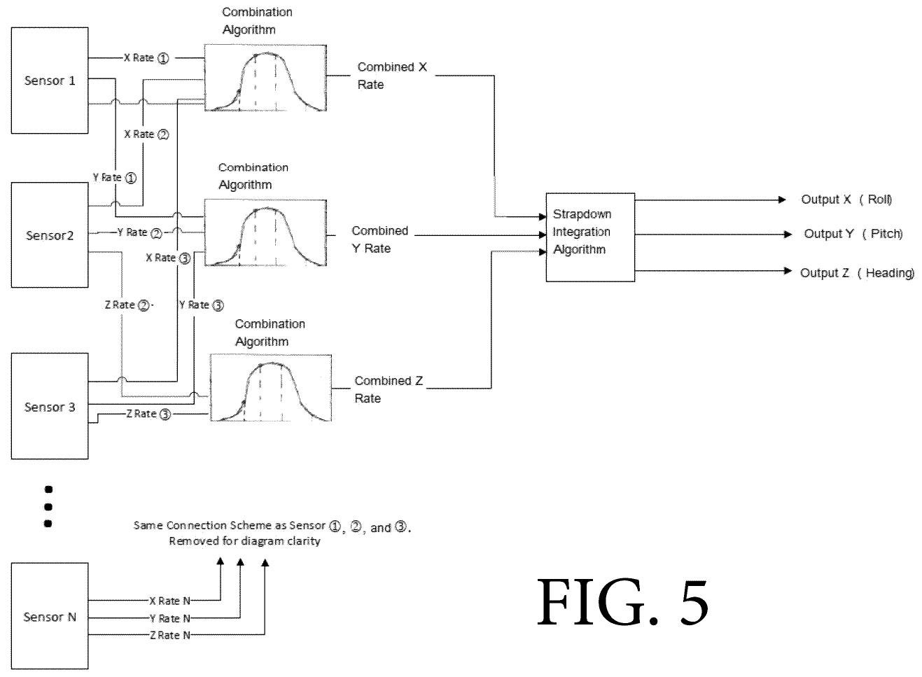

### Example Embodiment—FIG. 5

FIG. 5 illustrates a connection scheme of a system according to another example embodiment in which a first one (e.g. x-rate/roll) of the three three-dimensional rate vectors from each sensor 110, 112, 114 may be fed into a first combination algorithm; a second one (e.g. y-rate/pitch) of the three three-dimensional rate vectors from each sensor 110, 112, 114 may be fed into a second combination algorithm; and a third one (e.g. z-rate/heading) of the three three-dimensional rate vectors from each sensor 110, 112, 114 may be fed into a third combination algorithm.

The combination algorithms according to the example embodiment of FIG. 5, which each receive, from the sensors, multiple outputs of a single rate vector, may operate analogously to any one or more of the combination algorithms discussed above with respect to the example embodiment of FIG. 2. For example, the algorithms may be operated by the controller 120, and each combination algorithm may simply average the input data, may use a weighted average calculated based on a calculated median or mean or a calculated circular median or weighted circular mean. Furthermore, the combination algorithms may iteratively determine a Gaussian curve for each of the plurality of outputs and may iteratively weight the outputs based on their position on the curve, or may assume noise to be additive white Gaussian and thereby denoise the signal, and/or may operate according to any one of various other solutions as discussed herein or as would be understood by one of skill in the art.

According to the example embodiment of FIG. 5, the combined output of each of the combination algorithms may be input into a single strapdown integration algorithm. The strapdown integration algorithm of FIG. 5 may operate analogously to any one of the strapdown algorithms discussed above with respect to FIG. 2.

### Navigational System—Example Embodiments

The controller 120 can transmit the final output roll, pitch, and heading of the device, for example to a navigation system 130, as shown in FIG. 1. The navigation system 130 of the device may, for example, be an autopilot system. The navigation system 130 may include its own memory, processors, computer program instructions, and the like. Alternatively, the navigation system 130 may integrated with the controller 120 as a single unit, including by way of example only as a single chip.

According to one or more example embodiments, the navigational system 130 may, based one or more outputs from the controller 120, provide commands to control surface(s) 140 of the device and/or provide commands to engine(s) 145 of the device. For example, the navigational system 130 may determine that a roll, pitch, or heading of the device should be altered, and consequently may send a message to a rudder, as an example of control surface(s) 140, to change positions. According to one or more example aspects, a control surface of a device may be, but is not limited to a rudder, elevator, or aileron. In a copter-based implementation, such as a quadcopter or any other multirotor helicopter, the engine(s) 145 may similarly have its speed adjusted by the navigation system 130 to correct a roll, pitch, or heading to a desired roll, pitch, or heading based on information provided from the controller 120 based on data sourced by three-axis sensors 110, 112, 114.

### User Interface—Example Embodiments

The controller 120 may also provide information, based on data sourced by three-axis sensors 110, 112, 114, to at least one user interface 150. The interface may be a user interface of a navigational display either in the device (as shown in FIG. 1) or remote from the device (not pictured). The user interface 150 may have its own graphics card, display, processor, and memory, or may be integrated with the controller 120. The user interface 150 may use the information from controller 120 to display the device and/or the environment of the device in an appropriate attitude. The user interface 150 and navigation system 130 may receive additional information from other units, such as from an altimeter 160, which may be a barometric altimeter.

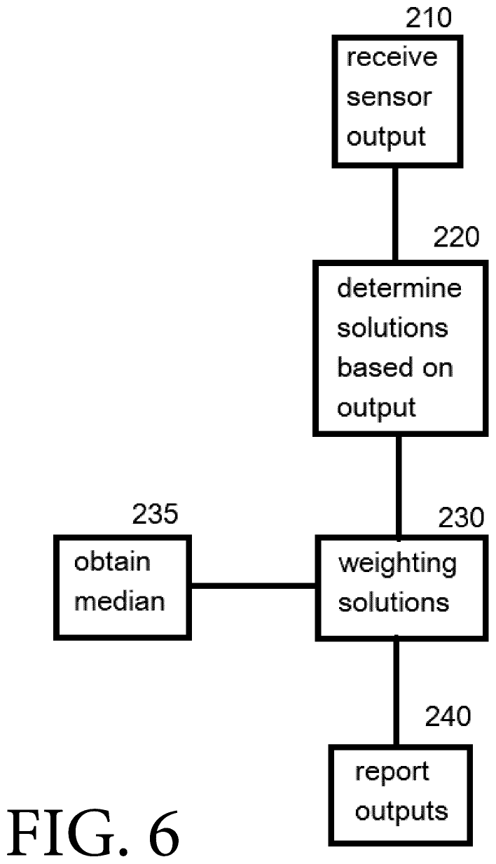

### Methods—Example Embodiment FIG. 6

FIG. 6 illustrates a method according to an example embodiment. The method of FIG. 6 may, for example, be implemented using the example embodiment of the system of FIG. 1 and the controller 120 embodied as shown with respect to the example embodiment of FIG. 2. The example method of FIG. 6 includes: the controller receiving outputs from a plurality of three-axis sensors (210); computing a plurality of solutions corresponding to the plurality of three-axis sensors (220); weighting each of the plurality of solutions based on a relation between a given solution and the other solutions of the plurality of solutions (230); and reporting/outputting a plurality of outputs, for example, each of an X output, a Y output, and a Z output, corresponding, for example, to a roll, a pitch, and a heading (240).

The outputs from the plurality of three-axis sensors (210) may be, for example, an x rate, a y-rate, and a z-rate, and may be output from sensors 110, 112, and 114, as shown in FIG. 2. The x rate, y rate, and z rate may correspond to a roll, a pitch, and a heading, respectively, or to other measurements, and the sensors may alternately output only two rates, for example, an x rate corresponding to a roll and a y rate corresponding to a pitch.

The computing the plurality of solutions (220) may be strapdown integration solutions executed, for example, by the strapdown integration algorithms of the controller. The weighting each of the plurality of solutions (230) may be weighting performed by combination algorithms of the controller, as discussed according to any of the example embodiments described herein. The weighting can be performed separately for a heading, also as discussed according to any of the example embodiments described herein.

The reporting/outputting the plurality of outputs (240) may include reporting/outputting to any one or more of various devices including, but not limited to: a navigation system and a user interface of an aircraft. The reporting may be direct or via another apparatus, and may be via a wired or wireless communication.

According to an example aspect, the method of FIG. 6 may also include obtaining a median of the plurality of solutions (235). This may be part of the weighting (230), and the relation by which the weighting occurs may be a relation to the median. The median of at least one of the roll, the pitch, or the heading may be determined by computing a circular median or circular mean, or by any of various other operations, as described above, and as would be understood by one of skill in the art.

According to various example aspects of an example embodiment, the weighting (230) may include weighting a given solution of the plurality of solutions based on its position on a Gaussian curve, or other curve, as would be understood by one of skill in the art, as discussed above.

According to an example aspect of one or more example embodiments, the weighting (230) may include iteratively determining a Gaussian curve for each of a plurality of outputs, as discussed above, for example with respect to the example embodiment of FIG. 2.

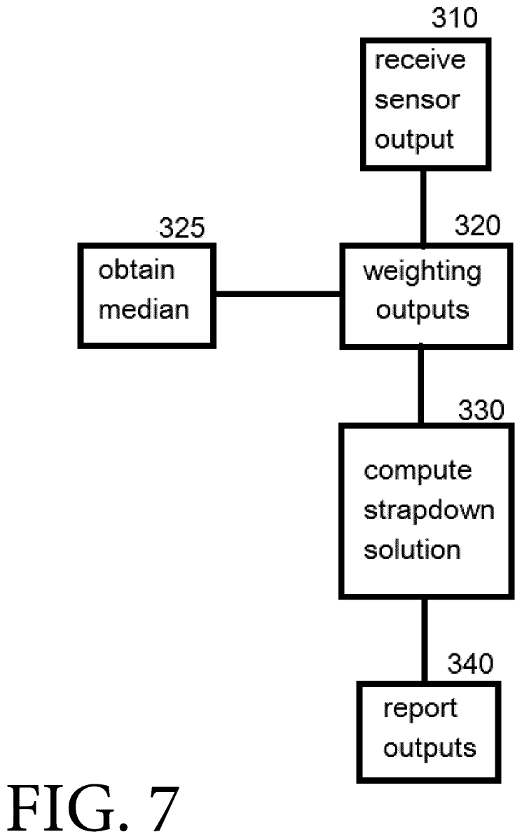

### Method—Example Embodiment FIG. 7

FIG. 7 illustrates a method according to another example embodiment. The method of FIG. 7 may, for example, be implemented using the example embodiment of the system of FIG. 1 and the controller 120 embodied as shown with respect to the example embodiment of FIG. 5. The example method of FIG. 7 includes: the controller receiving outputs from a plurality of three-axis sensors (310); weighting the outputs of each of the sensors based on a relation between an output from a given sensor and outputs from each of the other sensors (320); performing a strapdown integration operation on the weighted outputs (330); and reporting/outputting a plurality of outputs, for example, each of an X output, a Y output, and a Z output, corresponding, for example, to a roll, a pitch, and a heading (340).

The outputs from the plurality of three-axis sensors (310) may be, for example, an x rate, a y-rate, and a z-rate, and may be output from sensors 110, 112, and 114, as shown in FIG. 5. The x rate, y rate, and z rate may correspond to a roll, a pitch, and a heading, respectively, or to other measurements, and the sensors may alternately output only two rates, for example, an x rate corresponding to a roll and a y rate corresponding to a pitch.

The weighting the outputs (320) may include weighting the first outputs (e.g. x-rates/roll) from each sensor 110, 112, 114 with respect to each other; weighting the second outputs (e.g. y-rate/pitch) from each sensor 110, 112, 114 with respect to each other; and weighting the third outputs (e.g. z-rates/heading) from each sensor 110, 112, 114 with respect to each other. Alternately, as discussed with respect to the example embodiment of FIG. 5, each sensor may output only two rates, and thus, only first and second outputs from each sensor may be weighted. The weighting (320) may be performed by combination algorithms of the controller, as discussed according to any of the example embodiments herein.

According to an example aspect, the method of FIG. 7 may also include obtaining a median of the plurality of solutions (325). This may be part of the weighting (320), and the relation by which the weighting occurs may be a relation to the median. The median of at least one of the roll, the pitch, or the heading may be determined by computing a circular median or circular mean, or by any of various other operations, as described above, and as would be understood by one of skill in the art.

According to various example aspects of an example embodiment, the weighting (320) may include weighting a given solution of the plurality of solutions based on its position on a Gaussian curve, or other curve as would be understood by one of skill in the art, as discussed above.

According to an example aspect of one or more example embodiments, the weighting (320) may include iteratively determining a Gaussian curve for each of a plurality of outputs, as discussed above, for example with respect to the example embodiment of FIG. 2 or FIG. 5.

The performing the strapdown integration operation (330) may be a strapdown integration operation executed, for example, by a strapdown integration algorithm of the controller and as discussed, for example, with respect to any of the embodiments described herein.

The reporting/outputting the plurality of outputs (340) may include reporting/outputting to any one or more of various devices including, but not limited to: a navigation system and a user interface of an aircraft. The reporting may be direct or via another apparatus, and may be via a wired or wireless communication.

One or more example embodiments described herein may be practically applied in an aircraft, such as a UAV. Nevertheless, one or more example embodiments may be used in any of a variety of manned and unmanned aircraft, including rotorcraft, spacecraft, UAVs, and missiles, in any of a variety of manned and unmanned watercraft, including surface craft, hovercraft, and submarines, and in hand-held devices. Other practical implementations and use cases are also considered.

It may be understood that the example embodiments described herein may be considered in a descriptive sense only and not for purposes of limitation. Descriptions of features or aspects within each example embodiment may be considered as available for other similar features or aspects in other example embodiments.

While example embodiments have been described with reference to the figures, it will be understood by those of ordinary skill in the art that various changes in form and details may be made therein without departing from the spirit and scope as defined by the following claims.

What is claimed is:

1. An inertial navigation method of a vehicle, the method comprising:
receiving, at a controller of the vehicle, at each of a plurality of iterations, a plurality of first outputs from a corresponding plurality of sensors; and a plurality of second outputs from the corresponding plurality of sensors;
at each of the plurality of iterations:
applying a first Gaussian curve to the plurality first outputs; and a second Gaussian curve to the plurality of second outputs;
weighting each of the plurality of first outputs based on a position on the first Gaussian curve of each of the plurality of first outputs; and each of the plurality of second outputs based on a position on the second Gaussian curve of each of the plurality of second outputs;
determining a combined first output based on the weighting of the plurality of first outputs and determining a combined second output based on the weighting of the plurality of second outputs; and
calculating a roll of the vehicle based on the combined first output, and a pitch of the vehicle based on the combined second output; and
at each of the plurality of iterations: controlling at least one of an engine and a control surface of the vehicle based on the roll of the vehicle and the pitch of the vehicle.

2. The inertial navigation method according to claim 1, further comprising:
at each of the plurality of iterations: outputting the roll of the vehicle and the pitch of the vehicle to a navigation system of the vehicle;
wherein the controlling comprises the navigation system of the vehicle controlling the at least one of the engine and a control surface of the vehicle.

3. The inertial navigation method according to claim 1, wherein the first Gaussian curve is one of a first Probability Distribution Function, a first Cauchy Distribution, and a first Logistic Distribution, and the second Gaussian curve is one of a second Probability Distribution Function, a second Cauchy Distribution, and a second Logistic Distribution.

4. The inertial navigation method according to claim 1, wherein:
the receiving further comprises, at each of the plurality of iterations: a plurality of third outputs from the corresponding plurality of sensors;
at each of the plurality of iterations:
the applying further comprises applying a third Gaussian curve to the plurality of third outputs;
the weighting further comprises weighting each of the plurality of third outputs based on a position on the third Gaussian curve of each of the plurality of third outputs;
the determining further comprises determining a combined third output based on the weighting of the plurality of third outputs; and
the calculating further comprises calculating a heading of the vehicle based on the combined third output; and
at each of the plurality of iterations, the controlling further comprises controlling the at least one of the engine and the control surface of the vehicle based on the heading of the vehicle.

5. A vehicle comprising:
an engine; and
an inertial navigation system comprising:
a plurality of sensors, each configured to measure a first physical quantity from which can be computed a roll of the vehicle, and a second physical quantity from which can be computed a pitch of the vehicle;
a memory storing instructions therein; and
a controller, operatively coupled to each of the plurality of sensors, the controller configured to execute the instructions and thereby:
receive a plurality of first outputs, corresponding to the first physical quantity, from the plurality of sensors, and receive a plurality of second outputs, corresponding to the second physical quantity, from the plurality of sensors;
apply a first Gaussian curve to the plurality of first outputs and apply a second Gaussian curve to the plurality of second outputs;
weight each of the plurality of first outputs based on a position on the first Gaussian curve of each of the plurality of first outputs and weight each of the plurality of second outputs based on a position on the second Gaussian curve of each of the plurality of second outputs;
determine a combined first output based on the weighting of the plurality of first outputs and determine a combined second output based on the weighting of the plurality of second outputs;
calculate a roll of the vehicle based on the combined first output, and calculate a pitch of the vehicle based on the combined second output; and
control at least one of the engine and a control surface of the vehicle based on the roll of the vehicle and the pitch of the vehicle.

6. The vehicle according to claim 5, wherein the first Gaussian curve is one of a first Probability Distribution Function, a first Cauchy Distribution, and a first Logistic Distribution, and the second Gaussian curve is one of a second Probability Distribution Function, a second Cauchy Distribution, and a second Logistic Distribution.

7. The vehicle according to claim 5, wherein
each of the plurality of sensors is further configured to measure a third physical quantity from which can be computed a heading of the vehicle; and
the controller is further configured to:
receive a plurality of third outputs, corresponding to the third physical quantity, from the plurality of sensors,
apply a third Gaussian curve to the plurality of third outputs,
weight each of the plurality of third outputs based on a position on the third Gaussian curve of each of the plurality of third outputs,
determine a combined third output based on the weighting of the plurality of third outputs,
calculate a heading of the vehicle based on the combined third output, and
control the at least one of the engine and the control surface of the vehicle based on the heading of the vehicle.

8. The vehicle according to claim 7, wherein the first Gaussian curve is one of a first Probability Distribution Function, a first Cauchy Distribution, and a first Logistic Distribution;
the second Gaussian curve is one of a second Probability Distribution Function, a second Cauchy Distribution, and a second Logistic Distribution; and the third Gaussian curve is one of a third Probability Distribution Function, a third Cauchy Distribution, and a third Logistic Distribution.

9. A non-transitory computer-readable medium encoded with instructions that, when executed in hardware, perform an inertial navigation process comprising:
receiving, at each of a plurality of iterations, a plurality of first outputs from a corresponding plurality of sensors; and a plurality of second outputs from the corresponding plurality of sensors;
at each of the plurality of iterations:
applying a first Gaussian curve to the plurality first outputs; and a second Gaussian curve to the plurality of second outputs;
weighting each of the plurality of first outputs based on a position on the first Gaussian curve of each of the plurality of first outputs; and each of the plurality of second outputs based on a position on the second Gaussian curve of each of the plurality of second outputs;
determining a combined first output based on the weighting of the plurality of first outputs and determining a combined second output based on the weighting of the plurality of second outputs; and
calculating a roll based on the combined first output, and calculating a pitch based on the combined second output.

10. The non-transitory computer-readable medium according to claim 9, wherein the inertial navigation process further comprises at each of the plurality of iterations: outputting the roll and the pitch to a navigation system.

11. The non-transitory computer-readable medium according to claim 9, wherein the first Gaussian curve is one of a first Probability Distribution Function, a first Cauchy Distribution, and a first Logistic Distribution, and the second Gaussian curve is one of a second Probability Distribution Function, a second Cauchy Distribution, and a second Logistic Distribution.

12. The non-transitory computer-readable medium according to claim 9, wherein:
the receiving further comprises: at each of the plurality of iterations, receiving a third plurality of outputs from the corresponding plurality of sensors; and
at each of the plurality of iterations:
the applying further comprises applying a third Gaussian curve to the plurality of third outputs,
the weighting further comprises weighting each of the plurality of third outputs based on a position on the third Gaussian curve of each of the plurality of third outputs,
the determining further comprises determining a combined third output based on the weighting of the plurality of third outputs, and
the calculating further comprises calculating a heading of the vehicle based on the combined third output.

13. The non-transitory computer-readable medium according to claim 12, wherein the inertial navigation process further comprises at each of the plurality of iterations: outputting the roll, the pitch, and the heading to a navigation system.

14. The non-transitory computer-readable medium according to claim 12, wherein the first Gaussian curve is one of a first Probability Distribution Function, a first Cauchy Distribution, and a first Logistic Distribution; the second Gaussian curve is one of a second Probability Distribution Function, a second Cauchy Distribution, and a second Logistic Distribution; and the third Gaussian curve is one of a third Probability Distribution Function, a third Cauchy Distribution, and a third Logistic Distribution.
